(19) United States
(12) Patent Application Publication
(10) Pub. No.: US 2026/0037058 A1
(43) Pub. Date: Feb. 5, 2026

(54) BODY DRIVEN HUMAN MACHINE INTERFACE CONTROLLER AND METHODS OF USE

(71) Applicant: Glosdex, Inc., Atlanta, GA (US)

(72) Inventor: Simon Williams, San Jose, CA (US)

(21) Appl. No.: 19/284,917

(22) Filed: Jul. 30, 2025

Related U.S. Application Data
(60) Provisional application No. 63/676,978, filed on Jul. 30, 2024.

(51) Int. Cl. G06F 3/01

(52) U.S. Cl. CPC G06F 3/012; G06F 3/017

(57) ABSTRACT

A system for remotely controlling an appliance/device by a user includes a tracer affixed to a face or thumb of the user, wherein a change in position of the face/thumb of the user changes position of the tracer, a tracer position sensor positioned proximate said tracer, said tracer sensor configured to detect a position of said tracer relative to said tracer sensor, a processor control unit having a processor, a power supply, a memory, and a communications system to process a tracer sensor signal based on the detected position of said tracer relative to said tracer sensor into a command, and said processor communicates said command to the appliance/device via said communications system, and thus enables hands free commands to be communicated to an appliance/device.

### CROSS-REFERENCE TO RELATED APPLICATIONS

To the full extent permitted by law, the present United States Non-Provisional patent application hereby claims priority to and the full benefit of United States Provisional application entitled “FACE DRIVEN HUMAN MACHINE INTERFACE AND METHODS OF USE,” having assigned Ser. No. 63/676,978, filed on Jul. 30, 2024, incorporated herein by reference in its entirety.

### FIELD OF THE DISCLOSURE

The present disclosure is directed to controllers. More specifically, the present disclosure is directed to an apparatus to provide control via facial movement of a sensor.

### BACKGROUND

Handheld controllers have long been integral to user interaction with electronic devices, particularly in gaming, virtual reality (VR), augmented reality (AR), and other interactive systems. Early examples, such as the joystick and gamepad designs from the 1970s and 1980s, established foundational input mechanisms using buttons, directional pads, and analog sticks. These controllers typically relied on wired connections and offered limited input options, primarily focusing on 2D navigation and discrete button presses. Over time, advancements introduced wireless connectivity (e.g., Bluetooth, RF protocols) and additional input modalities, such as accelerometers and gyroscopes. However, these controllers often lacked precision in tracking spatial orientation and required additional external sensors (e.g., infrared bars or cameras) to achieve accurate motion detection, limiting their portability and increasing system complexity. Newer systems often rely on external tracking stations or cameras to monitor controller position in 3D space, which improves accuracy but increases setup complexity and cost. Despite these advancements, current handheld controllers face limitations in balancing precise 3D tracking, low latency, and ergonomic design, creating a need for more integrated and versatile solutions.

Quick-service food and fast casual dining establishments provide customers with low-cost disposable beverage cups (especially for soda drinks) and lids to add structure to the cup and prevent spilling while in transport; such lids require a straw to access fluid in the container or cup with a lid. Straws provide safety advantages compared to sipping beverages without straws (with or without sip lids); appropriate material straws are required (for cold and hot drinks) for persons with a spectrum of physical challenges.

Therefore, it is readily apparent that there is a recognizable unmet need for a body driven human machine interface controller and methods of use that may be configured to address at least some aspects of the problems discussed above.

### SUMMARY

Briefly described, in an example embodiment, the present disclosure may overcome the above-mentioned disadvantages and may meet the recognized need for a body driven human machine interface controller and methods of use to provide a controller for seamless interaction with electronic devices, including gaming, virtual reality (VR), and augmented reality (AR) systems, integrating high-precision 3D motion tracking, ergonomic design, and low-latency wireless connectivity in a self-contained unit that eliminates the need for handheld sensors. Utilizing a novel combination of advanced inertial measurement units (IMUs), embedded machine learning for real-time gesture recognition, and customizable haptic feedback, the controller delivers intuitive and immersive user experiences. Its innovative sensor fusion and predictive algorithms ensure accurate spatial tracking and orientation, while a modular input system accommodates diverse user preferences and accessibility needs. This compact, cost-effective solution enhances portability and versatility, overcoming limitations of prior art by providing a standalone, high-performance controller for interactive applications.

Moreover, present disclosure provides a tracer that utilizes, for example, biocompatible neodymium magnetic markers, each with a magnetic strength of 0.5-1.0 Tesla and dimensions of 2-3 mm, affixed to precise facial locations (e.g., checks, jawline) or finger/thumb using hypoallergenic adhesive patches, medical-grade Band-Aids, or flexible silicone tape, enabling detection of micro-movements such as cheek displacement (via blowing or tongue manipulation) with a resolution of 0.3 mm. These movements are captured by tracer position sensor system, typically positioned near the ears in a compact form factor resembling wireless earbuds or integrated into devices like VR headsets or smart glasses or positioned on finger/wrist, utilizing a hybrid sensor array of triaxial magnetometers, multi-axis, such as 6-axis inertial measurement units (IMUs) with 100 Hz sampling rates, and infrared depth sensors for enhanced spatial tracking. The sensor units transmit raw movement data via a low-latency Bluetooth Low Energy (BLE) 5.2 connection (with a 2 ms latency and 10-meter range) or a USB 116 wired interface to a central processing element (CPE)-based controller, powered by a 32-bit ARM Cortex-M7 processor at 400 MHZ, 4 MB flash memory, and 1 MB RAM, which applies machine learning algorithms (e.g., neural networks trained on gesture datasets) to convert detected movements into human-machine interface (HMI) commands, such as right-clicks or mouse pointer movements, with a processing delay under 5 ms. The CPE controller, equipped with a 3.7V 300 mAh lithium-ion battery providing 15 hours of operation, is rechargeable via the USB 116 port, which also supports firmware updates. A user-configurable calibration tool, accessible via a companion software application on a connected device, leverages a graphical interface to allow users to map specific facial and head movements to customizable commands, adjust sensitivity thresholds, and perform system calibration using real-time feedback loops to optimize detection accuracy for individual facial anatomies and movement patterns.

Furthermore, the present disclosure provides a hands-free control system for interacting with computing environments, such as smartphones, computers, and virtual reality (VR) headsets, by translating facial and head movements into specific commands, leveraging advanced sensor technologies and machine learning algorithms to eliminate the need for manual input devices. In one embodiment, a high-resolution facial tracking system, detects micro-movements of the right check to emulate, for example, a right mouse click and left cheek movements to emulate a left mouse click, with a detection accuracy of within 0.5 mm. In another embodiment, head movements are tracked using a combination of inertial measurement units (IMUs) with 6-axis gyroscopes and accelerometers, coupled with real-time sensor fusion algorithms, to map head tilts, eye brow movement, eye wink, and other facial muscle, nostril, ear, mouth, lips, or the like to emulate precise cursor movements on a screen or other user decision, achieving sub-millisecond latency. Additional embodiments include translating head rotations, into selection commands on smart devices, and mapping right cheek twitches to a “pinch” gesture in VR environments for intuitive object manipulation. Similarly, left check movements can trigger a select command on a computer, processed through a neural network trained to distinguish intentional gestures from involuntary movements, ensuring robust command execution across diverse applications with minimal calibration.

Accordingly, in one aspect, the present disclosure may include a face-mounted tracer system with, for example, an array of miniaturized, biocompatible magnetic markers, embedded in flexible, skin-adhesive patches or integrated into a lightweight headset, coupled with a high-sensitivity electromagnetic tracking module that employs triaxial magnetometers and machine learning-enhanced signal processing to detect sub-millimeter facial muscle movements and head orientations with a sampling rate of 120 Hz, enabling precise, real-time translation of these movements into control commands for computing environments.

Accordingly, in another aspect, the present disclosure may include a tracer position sensor, for example, a compact, wearable device integrating, for example, a high-resolution sensor array (comprising 6-axis IMUs with gyroscopes and accelerometers, infrared depth sensors, and triaxial magnetometers), a low-power 32-bit ARM Cortex-M7 CPU with 400 MHz processing capability, 2 MB of flash memory and 512 KB of RAM for real-time data processing and gesture recognition capability, a 3.7V 250 mAh lithium-ion battery providing up to 12 hours of continuous operation, USB interface for charging and firmware updates, and communication components, such as Bluetooth Low Energy (BLE) 5.0 module for low-latency wireless communication with a range of up to 10 meters, enabling precise tracking of facial and head movements via tracer for hands-free control of computing environments.

In an exemplary embodiment of a system for remotely controlling a computing device by a user movement of an exterior body part, having a tracer configured to be affixed to the exterior body part of the user, wherein a change in position of the body part changes a position of the tracer, a tracer position sensor system positioned proximate to the tracer, the tracer position sensor system configured to detect a position of the tracer relative to the tracer position sensor system, a processor control unit having a processor, a power supply, a memory, and a communications system, the processor configured to process a tracer sensor signal based on the detected the position of the tracer and convert the position into a human-machine interface (HMI) command; and the communications system configured to transmit the HMI command to the computing device, thereby enabling hands-free control of the computing device.

In a second exemplary embodiment of an apparatus to a body-driven human-machine interface (HMI) controller system by a user movement of an exterior body part, such as a facial location having a tracer configured as a neodymium magnetic marker affixed to the facial location of the user, a tracer position sensor system positioned proximate to the facial location and having a Hall Effect sensor configured to detect micro-movements of the tracer, a processor control unit having a processor, a battery, a memory, and a communications system with a Bluetooth Low Energy (BLE) and a USB interfaces, configured to convert detected micro-movements into HMI commands with a processing latency of less than 5 ms; and a configuration/calibration tool executable on a computing device, configured to map the micro-movements to user-defined HMI commands via a graphical user interface and stores such information in RAM or cloud-based synchronization with encryption.

In a third exemplary embodiment of a method for hands-free control of a computing device using a body-driven human-machine interface (HMI) controller, having the steps of affixing a tracer to an exterior body part of a user, positioning a tracer position sensor system proximate to the tracer, detecting, by the tracer position sensor system, a position change of the tracer corresponding to a movement of the exterior body part with a resolution of at least 0.3 mm, processing, by a processor control unit, the detected position change into an HMI command using a machine learning algorithm, transmitting the HMI command to the computing device via a communications system, and configuring, via a configuration/calibration tool, a mapping of specific exterior body part movements to user-defined HMI commands.

A feature of the present disclosure includes providing a system that enables hands-free interaction with computing devices, eliminating the need for manual input devices and enhancing accessibility for users with limited hand mobility.

A feature of the present disclosure includes utilization of biocompatible neodymium magnetic markers with 0.5-1.0 Tesla strength ensures precise detection of facial micro-movements down to 0.3 mm resolution, surpassing the accuracy of conventional optical tracking systems.

A feature of the present disclosure includes integration of a hybrid sensor array (triaxial magnetometers, 6-axis IMUs, and infrared depth sensors) in a compact, ear-mounted or device-integrated form factor provides robust 3D spatial tracking without requiring external cameras or beacons, reducing setup complexity.

A feature of the present disclosure includes communication components, such as low-latency Bluetooth Low Energy (BLE) module connectivity with 2 ms latency and USB interface ensures rapid and reliable transmission of movement data to the CPE-based controller, improving responsiveness over traditional wired controllers.

A feature of the present disclosure includes a 32-bit ARM Cortex-M7 processor with 400 MHz and machine learning algorithms enables real-time gesture recognition and command translation with a processing delay under 5 ms, offering superior performance compared to prior art motion-based controllers.

A feature of the present disclosure includes a customizable calibration tool which allows users to map specific facial and head movements to tailored HMI commands via a graphical interface, enhancing user adaptability and personalization compared to rigid input systems.

A feature of the present disclosure includes a 3.7V 300 mAh lithium-ion battery to provide up to 15 hours of continuous operation, offering extended usability without frequent recharging, unlike many existing wearable controllers.

A feature of the present disclosure includes modular integration into existing devices like VR headsets or smart glasses eliminates the need for standalone hardware, reducing cost and improving portability over multi-component tracking systems.

A feature of the present disclosure includes real-time feedback loops in the calibration software optimize detection accuracy for individual facial anatomies, addressing variability in user physiology more effectively than static calibration methods.

A feature of the present disclosure includes the use of hypoallergenic adhesive patches and medical-grade materials for tracer attachment ensures user comfort and safety during prolonged use, overcoming ergonomic limitations of earlier facial tracking solutions.

A feature of the present disclosure is its ability to allow a user to interface with a multitude of computer systems without the use of their hands. This is applicable to multiple use cases where the hands are being used for other purposes.

Another feature of the present disclosure is its ability to allow the user to interface with a multitude of computer systems when the environment does not permit hand gestures to be recognized (e.g. low light)

Another feature of the present disclosure is its ability to allow a person with limited to no use of their hands to interface with a multitude of computer systems.

These and other features of the for a body driven human machine interface controller and methods of use will become more apparent to one skilled in the art from the prior Summary and following Brief Description of the Drawings, Detailed Description of exemplary embodiments thereof, and Claims when read in light of the accompanying Drawings or Figures.

### BRIEF DESCRIPTION OF THE DRAWINGS

The present disclosure for a body driven human machine interface controller and methods of use will be better understood by reading the Detailed Description of the Preferred and Selected Alternate Embodiments with reference to the accompanying drawing Figures, in which like reference numerals denote similar structure and refer to like elements throughout, and in which:

FIG. 1A is a side view of a user with body driven human machine interface controller shown affixed to their face and ear according to select embodiments of the disclosure;

FIG. 1B is a side view of a user with body driven human machine interface controller shown affixed to their face and eyewear according to select embodiments of the disclosure;

FIG. 1C is a side perspective view of a user with hand driven human machine interface controller shown affixed to a glove according to select embodiments of the disclosure;

FIG. 1D is a side perspective view of a user with hand driven human machine interface controller shown integrated into a piece(s) of jewelry according to select embodiments of the disclosure;

FIG. 2 is a block diagram of the tracer position sensor system and electronics according to select embodiments of the disclosure in FIG. 1;

FIG. 3 is a block diagram of the tracer position sensor system of FIG. 2 in communication with a computer and/or smart phone according to select embodiments of the disclosure;

FIG. 4 is a block diagram of the tracer position sensor system of FIG. 2 in communication with a VP headset, computer, and/or smart phone according to select embodiments of the disclosure; and

FIGS. 5A and 5B is flowchart of the method and/or operational steps of the body driven human machine interface controller, according to select embodiments of the disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

In describing the exemplary embodiments of the present disclosure, as illustrated in the figures, specific terminology is employed for clarity. The present disclosure, however, is not intended to be limited to the specific terminology selected; it is to be understood that each specific element includes all technical equivalents that operate in a similar manner to accomplish similar functions. Embodiments of the claims may, however, be embodied in many different forms and should not be construed as limited to the embodiments set forth herein. The examples set forth herein are non-limiting examples and are merely examples among other possible examples. It is recognized herein that the optimum dimensional relationships, to include variations in size, materials, shape, form, position, connection, function and manner of operation, assembly and use, are intended to be encompassed by the present disclosure.

User herein may be human, robot, machine, animal, or hybrid human/animal machine.

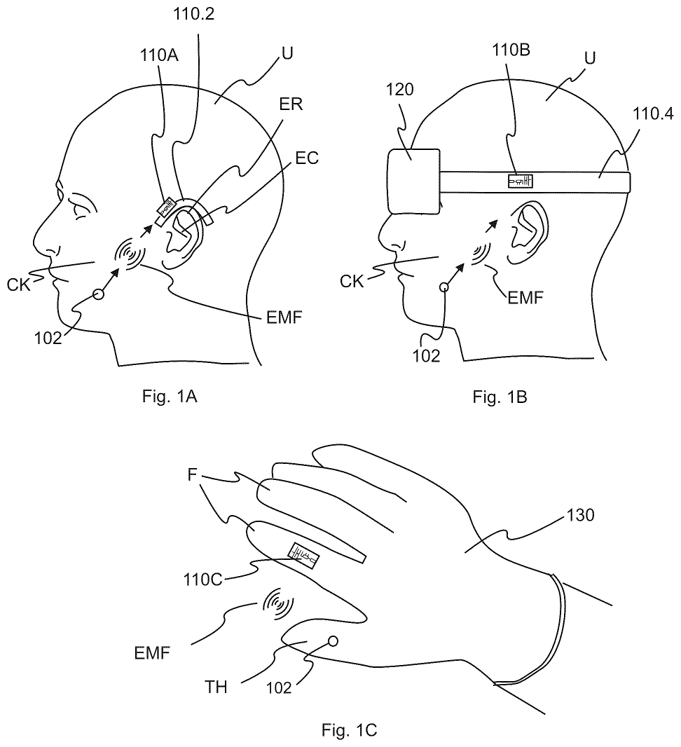

Referring now to FIGS. 1A, 1B, 1C and 1D, by way of example, and not limitation, there is illustrated an example embodiment of body driven human machine interface controller 100. In one embodiment, as shown in FIG. 1, body driven human machine interface controller 100A may include tracer 102, which may be affixed to user U, such as affixed to the side of the face F using for example, a hypoallergenic adhesive patch to removably adhere tracer 102 to user U. However, it is contemplated herein that tracer 102 may utilize other multiple attachment means and configurations for the placement of tracer 102 thereon user U. More specifically, tracer 102 may be configured as a biocompatible neodymium magnetic marker, and having a biocompatible neodymium magnetic marker magnetic strength of 0.5-1.0 Tesla EMF and dimensions of 2-3 mm. Preferably, tracer 102 may be affixed to precise facial locations (e.g., cheeks, jawline, upper lip, lower lip, eyelid, eyebrow, forehead, nose, thumb, or the like (the “exterior body part”)) using hypoallergenic adhesive patches, medical-grade Band-Aids, or flexible silicone tape, enabling detection of micro-movements, such as check displacement (via blowing or tongue manipulation) with a resolution of 0.3 mm or better.

Moreover, body driven human machine interface controller 100A may include tracer position sensor system 110. Tracer position sensor system 110 may include a standalone, lightweight module and is preferably capable of capturing electromagnetic signal from tracer 102 and determining position of tracer 102 relative to tracer position sensor system 110A, such as different check CK movements of user U.

In one embodiment, tracer position sensor system 110A is typically positioned near the ears in a compact form factor resembling a hearing aid positioned over the ear or as an ear bud positioned in the ear canal (the “ear piece”). Tracer position sensor 110A may weigh(ing) approximately 15 grams and be ergonomically contoured to rest over the ear ER of user U, and secured with a flexible silicone clip 110.2, or contoured to fit the contour of the ear ER and ear canal EC if configured as an earbud ensuring stable positioning during dynamic facial movements.

In a second embodiment, tracer position sensor 110B is typically integrated into eyewear, such as VR headsets or smart glasses 120, and positioned near the ears in a compact form factor resembling eyewear frame temple supports or headband 110.4 (framework). For example, tracer position sensor 110B may be seamlessly integrated into a secondary device, such as virtual reality (VR) headset 304, like the Apple Vision Pro, leveraging the headset's existing framework to align sensors with the facial plane, minimizing additional hardware and ensuring stable positioning during dynamic facial movements.

In a third embodiment, tracer position sensor 110C is typically integrated into glove 130 and typically positioned proximate an index or pointer finger F of a glove (or other finger) and tracer 102 may be positioned on the thumb or thumb member TH of the glove.

In a fourth embodiment, tracer position sensor 110D is typically integrated into jewelry, such as a ring 132 or bracelet 131, and typically positioned proximate an index or pointer finger or wrist (or other finger) and tracer 102 may be positioned on thumb TH, other finger F.

It is contemplated herein that positioning of tracer position sensor 110 and tracer 102 may be swapped or reversed.

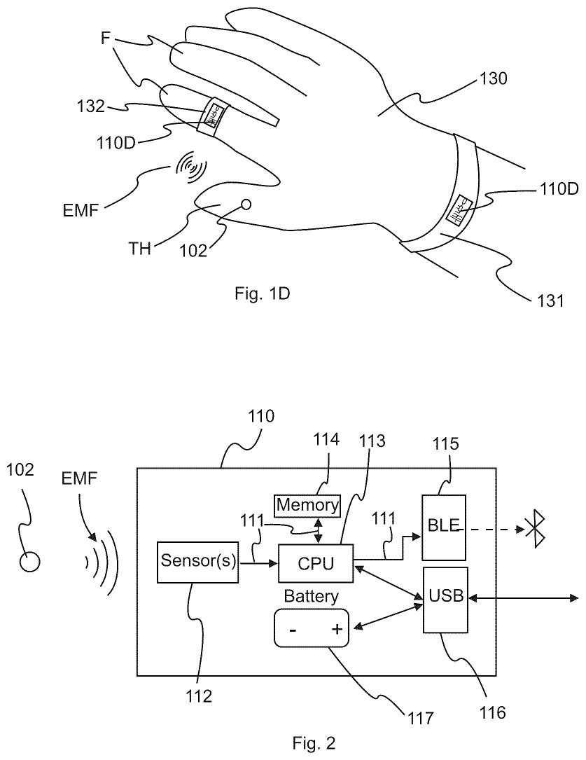

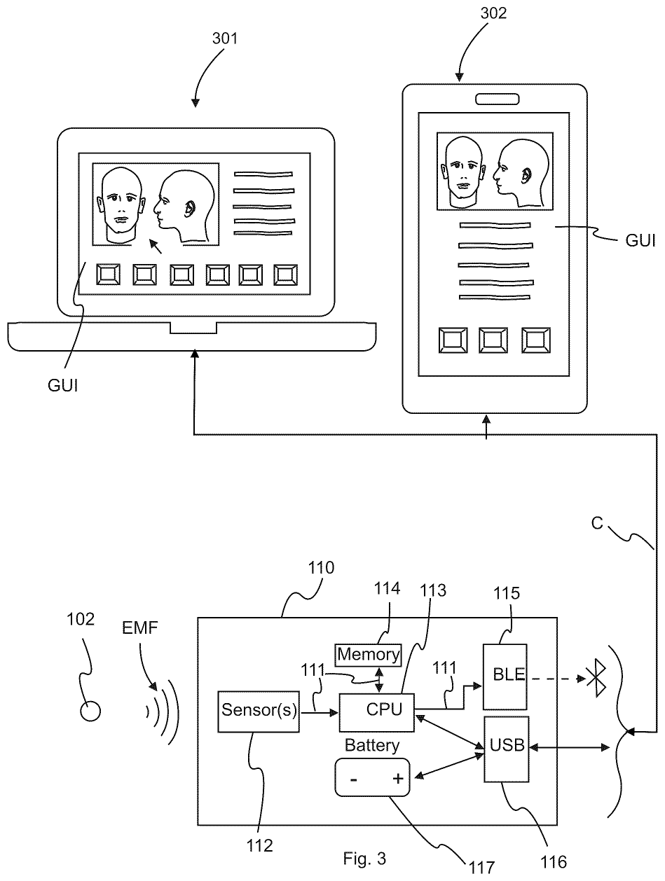

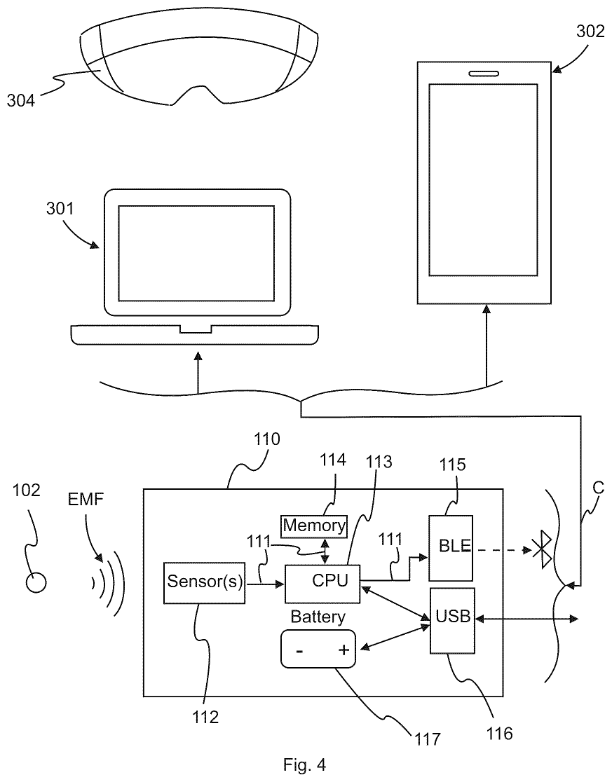

Referring now to FIGS. 2, 3 and 4, by way of example, and not limitation, there is illustrated an example embodiment of body driven human machine interface controller 100 and more specifically tracer 102, electromagnetic field EMF, and tracer position sensor 110. Moreover, tracer position sensor 110 may be configured with sensor 112 or a hybrid sensor array 112. Sensor 112 may include a Hall Effect sensor (sampling data at 120 Hz) that detects the Hall Effect which is the production of a voltage difference across an electrical conductor, transverse to an electric current in the conductor and to an applied magnetic field perpendicular to the current. Moreover, sensor 112 may include triaxial magnetometers, with multi-axis sensor, such as multi-axis (six 6) inertial measurement units (IMUs) with 100 Hz sampling rates. Furthermore, hybrid sensor array 112 may include infrared depth sensors, accelerometers, and/or gyroscopes for enhanced spatial tracking of tracer 102. Sensor 112 tracks tracer 102 position and transmits raw position and movement data via electrical connection 111, to controller or microcontroller, such as central processing unit (CPU)-based controller 113, powered by for example a 32-bit ARM Cortex-M7 processor at 400 MHZ. Central processing unit 113 converts raw position and movement data from tracer 102, into human-machine interface (HMI) commands C, such as right-clicks or mouse pointer movements and the like. Moreover, central processing unit 113 may utilize machine learning algorithms (e.g., neural networks trained on gesture datasets) to process and convert detected movements and position into machine interface (HMI) commands C, using, for example, 4 MB flash memory and 1 MB RAM 114 in communication via electrical connection 111 to central processing unit 113 with a processing delay under 5 ms. Central processing unit 113 may be equipped with a power supply, such as 3.7V 300 mAh lithium-ion battery 117 providing 15 hours of operation for body driven human machine interface controller. Battery 117 may be rechargeable via USB port 116, which also supports firmware updates into central processing unit 113 via flash memory and RAM memory 114. Furthermore, central processing unit 113 may be in communication via electrical connection 111 with communication components, such as low-latency Bluetooth Low Energy (BLE), 115, connection (with a 2 ms latency and 10-meter range) or USB 116 to transmit detected movements and position into machine interface (HMI) commands C to a device (other computer 301, smart phone 302, virtual reality (VR) headset 304, machine, robot, and the like as shown in FIGS. 3 and 4) being controlled by body driven human machine interface controller 100.

The tracer's 102 micro-movements, such as check displacements of 0.3-1.0 mm induced by blowing or tongue manipulation, are detected by tracer position sensor 110 with a sampling rate of approximately 120 Hz, enabling precise tracking of spatial coordinates in three dimensions to initiate human-machine interface (HMI) commands C, such as mouse clicks or gesture-based selections, robot movements, and the like with a detection latency of under 5 ms.

It is contemplated herein that tracer 102 position and t tracer position sensor 110 may be swapped.

Referring again to FIGS. 3 and 4, by way of example, and not limitation, there is illustrated computer 301 and smart phone 302 and virtual reality (VR) headset 304 which may be utilized as configuration/calibration devices designed to customize and optimize the functionality of body driven human machine interface controller 100. Computer 301 and smart phone 302 may be used to configure and calibrate tracer position sensor 110. This can be implemented, for example, as an application that runs on a computer 301 as desktop application 400 compatible with operating systems such as Windows, macOS, or Linux distributions, or an app on a smartphone 302 as an application 400 optimized for iOS and Android, ensuring seamless operation across diverse devices with a minimum hardware requirement of, for example, 2 GB RAM and 500 MB storage. The configuration/calibration devices, computer 301 and smart phone 302, establishes a robust interface with tracer position sensor 110 via communication components, such as Bluetooth Low Energy (BLE) 115, delivering a 2 Mbps data rate with a 2 ms latency and a 10-meter range, or a USB 116 communication connection 303 supporting a 5 Gbps transfer rate and 100 mA power delivery for simultaneous charging and data exchange, with both interfaces secured by AES-128 encryption for data integrity. This allows user U to configure what types of face movements apply to specific HMI commands C.

Software/Application 400 features an intuitive graphical user interface (GUI), supporting up to 4K resolution with adaptive scaling, enabling users to map specific facial movements—such as check displacements of 0.3-1.0 mm detected by Hall Effect sensors or head rotations within +45° tracked by a multi-axis IMU—to customizable human-machine interface (HMI) commands C, including mouse clicks, cursor navigation, or VR-specific gestures like “pinch” or “select,” configuration profile. Calibration is enhanced by a machine learning algorithm, leveraging a convolutional neural network trained on a dataset of over thousands of facial and head movement patterns (dataset of body movement patterns), which processes sensor inputs at 120 Hz to optimize detection accuracy within a 0.2 mm tolerance, offering real-time feedback through a dynamic visualization dashboard and supporting user-defined sensitivity adjustments to account for individual anatomical variations.

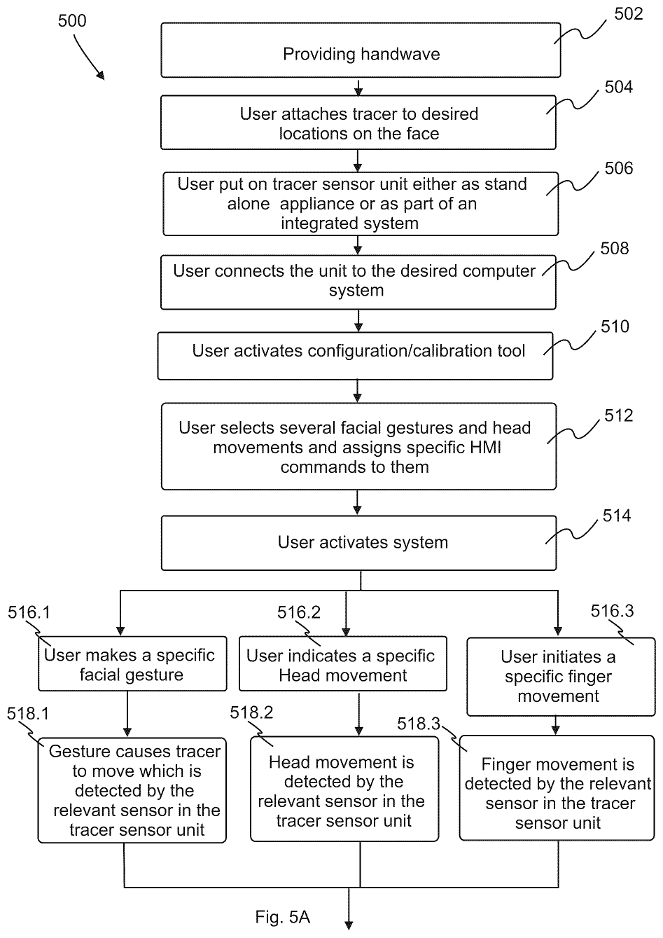

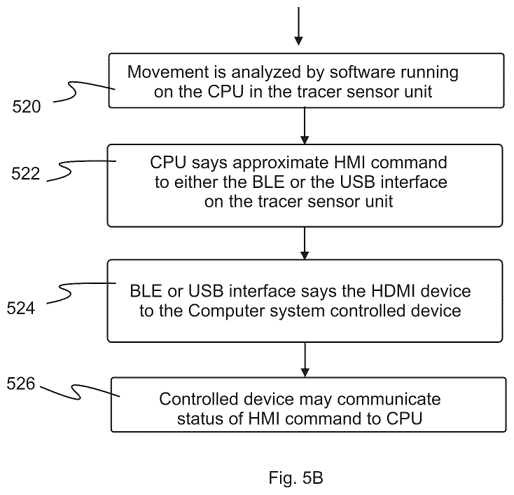

Referring now to FIG. 5, by way of example, and not limitation, there is illustrated an example embodiment of a flow diagram 500 of a method of utilizing software/application 400 to configure to configure and calibrate tracer position sensor system 110 as to what types of movements apply to specific HMI commands C, such as for mapping facial and head movements to specific human-machine interface (HMI) commands C in a hands-free control system. In block or step 502 providing body driven human machine interface controller 100 and more specifically tracer 102, tracer position sensor system 110, computer 301, and smart phone 302.

### Calibration/Setup

In block or step 504, user U attaches tracer 102 to desired user U body part location multidirectional movement, such as check CK of face F.

In block or step 506, user U attaches tracer 102 and tracer position sensor system 110 to desired user U body part location.

In block or step 508, user U connects body driven human machine interface controller 100 to computer 301 and smart phone 302 and virtual reality (VR) headset 304.

In block or step 510, user U activates (launching) software/application 400 on computer 301 and smart phone 302 and virtual reality (VR) headset 304 to configure/calibrate body driven human machine interface controller 100. Software/application 400 enters calibration mode, prompting user U to perform a sequence of facial movements (e.g., check CK displacements of 0.3-1.0 mm via blowing or tongue manipulation), head movements (e.g., rotations within ±45° along yaw, pitch, or roll axes), finger F/thumb TH detected tracer position sensor system 110, which includes a Hall Effect sensor (0.1-10 mT sensitivity), a multi-axis inertial measurement unit (IMU) with ±16 g accelerometer and ±2000°/s gyroscope resolution, and/or an infrared depth sensor with 0.2 mm precision, sampled at 120 Hz.

In block or step 512, user U selects several facial gestures, head movements, or finger/wrist movements (sequence of body part movements) and assigns/saves specific HMI commands C to such movements. Sensor 112 data is processed by a machine learning algorithm 400 embedded in computer 301 and smart phone 302 and virtual reality (VR) headset 304, utilizing a convolutional neural network trained on a dataset of thousands of movement patterns (dataset of body movement patterns), achieving a 98% classification accuracy to create a baseline movement profile stored in memory 114.

User U interacts with graphical user interface (GUI displaying) of computer 301 and smart phone 302 and virtual reality (VR) headset 304, to assign specific movements to HMI commands C, such as mapping check up twitch/finger up to a right mouse click, check down twitch/finger down movements to a left mouse click, or head tilts/finger left to right to cursor navigation, with sensitivity thresholds adjustable within a 0.1-1.0 mm range for personalized precision. Moreover, body driven human machine interface controller 100 validates the mappings by prompting user U to repeat movements, comparing real-time sensor outputs against the baseline profile to ensure a detection tolerance of 0.2 mm, and displays results via a dynamic visualization dashboard showing/displaying movement vectors and command triggers.

Finalized configuration profile is uploaded to tracer position sensor system 110, updating its firmware to execute (ing) commands with a processing latency of under 2 ms. Completing the configuration and calibration process for seamless hands-free interaction with computing environments, including smartphones 302, computers 301, or virtual reality (VR) headsets 304.

Moreover, configuration profile may be saved to a cloud-based server enabling profile portability across devices.

In block or step 514, user U activates body driven human machine interface controller 100.

### In Use

In block or step 516 user U makes a specific body part movement along with tracer 102. In block or step 516.1 user U makes a specific facial movement gesture, such as cheek CK movement. In block or step 516.2 user U makes a specific head H movement. In block or step 516.3 user U makes a specific finger F, thumb TH, or wrist WR movement.

In block or step 518, user's U specific body part movement via tracer 102 is detected by sensor 112 of tracer position sensor system 110. In block or step 518.1 user U makes a specific facial movement gesture, such as cheek CK via tracer 102 and such movement is detected by sensor 112 of tracer position sensor system 110. In block or step 516.2 user U makes a specific head H movement CK via tracer 102 and such movement is detected by sensor 112 of tracer position sensor system 110. In block or step 516.3 user U makes a specific finger F, thumb TH, or wrist WR movement CK via tracer 102 and such movement is detected by sensor 112 of tracer position sensor system 110.

In block or step 520, sensor 112 data is analyzed by central processing unit (CPU) of tracer position sensor system 110 and more specifically tracer position sensor system 110 maps or associates user U movement to specific HMI commands C (each a selection command) stored(s) in tracer position sensor system 110 and validating said movements against a baseline profile with a detection tolerance of 0.2 mm.

In block or step 522, central processing unit (CPU) 113 of tracer position sensor system 110 communicates HMI commands C to communication devices, such as Bluetooth Low Energy (BLE) 115 or USB 116.

In block or step 524, communication devices, such as Bluetooth Low Energy (BLE) 115 or USB 116 of tracer position sensor system 110 communicates HMI commands C to smartphones 302, computers 301, or virtual reality (VR) headsets 304 as well as communicate HMI commands C or other data to human, robot, machine, animal, or hybrid human/animal machine (controlled device or computing device) or save (ing) a configuration profile to a memory 114 or cloud-based synchronization/storage with encryption.

In block or step 526, smartphones 302, computers 301, or virtual reality (VR) headsets 304 as well as human, robot, machine, animal, or hybrid human/animal machine (controlled device or computing device) may communicate status of HMI commands C back through communication devices, such as Bluetooth Low Energy (BLE) 115 or USB 116 to central processing unit (CPU) 113 of tracer position sensor system 110.

Concerning the description herein, it is to be realized that the optimum dimensional relationships, including variations in size, materials, shape, form, configuration, position, connection, function and manner of operation, assembly and use, are intended to be encompassed by the present disclosure.

It is further understood herein that the parts and elements of this disclosure may be located or positioned elsewhere based on one of ordinary skill in the art without deviating from the present disclosure.

With respect to the above description, it is to be realized that the optimum dimensional relationships, including variations in size, materials, shape, form, position, movement mechanisms, function and manner of operation, assembly and use, are intended to be encompassed by the present disclosure.

The foregoing description and drawings comprise illustrative embodiments. Regarding the described exemplary embodiments, it should be noted by those skilled in the art that the disclosures within are exemplary only, and that various other alternatives, adaptations, and modifications may be made within the scope of the present disclosure. Merely listing or numbering the steps of a method in a particular order does not constitute any limitation on the order of the steps of that method. Many modifications and other embodiments will come to mind for one skilled in the art this disclosure pertains to, having the benefit of the teachings presented in the foregoing descriptions and the associated drawings. Although specific terms may be employed herein, they are used in a generic and descriptive sense only and not for purposes of limitation. Moreover, the present disclosure has been described in detail; it should be understood that various changes, substitutions and alterations can be made thereto without departing from the spirit and scope of the disclosure as defined by the appended claims. Accordingly, the present disclosure is not limited to the specific embodiments illustrated herein but is limited only by the following claims.

1. A system for remotely controlling a computing device by a user movement of an exterior body part, comprising:
a tracer configured to be affixed to the exterior body part of the user, wherein a change in position of the body part changes a position of said tracer;
a tracer position sensor system positioned proximate to said tracer, said tracer position sensor system configured to detect a position of said tracer relative to said tracer position sensor system; and
a processor control unit having a processor, a power supply, a memory, and a communications system, the processor configured to process a tracer sensor signal based on the detected said position of said tracer and convert said position into a human-machine interface (HMI) command; and said communications system configured to transmit said HMI command to the computing device, thereby enabling hands-free control of the computing device.

2. The system of claim 1, wherein said tracer provides a biocompatible neodymium magnetic marker with a magnetic strength of 0.5 to 1.0 Tesla and dimensions of 2 to 3 mm, affixed to the exterior body part using a hypoallergenic adhesive patch, medical-grade Band-Aid, flexible silicone tape.

3. The system of claim 1, wherein the exterior body part is selected from the group consisting of a cheek, jawline, upper lip, lower lip, eyelid, eyebrow, forehead, nose.

4. The system of claim 1, wherein said tracer position sensor system provides a sensor selected from the group consisting of a hybrid sensor array including a Hall Effect sensor with a sensitivity of approximately 0.1 to 10 mT, a multi-axis inertial measurement unit (IMU) with approximately a ±16 g accelerometer and ±2000°/s gyroscope, an infrared depth sensor with approximately 0.2 mm precision, and combinations thereof operating at a sampling rate of approximately 120 Hz and with a resolution of approximately at least 0.3 mm.

5. The system of claim 1, wherein said processor control unit provides a 32-bit ARM Cortex-M7 processor operating at approximately 400 MHZ, approximately 4 MB of flash memory, and approximately 1 MB of RAM, configured to execute machine learning algorithms for real-time gesture recognition with a processing delay of approximately less than 5 ms.

6. The system of claim 1, wherein said communications system provides a Bluetooth Low Energy (BLE) module with approximately a 2 Mbps data rate, approximately 2 ms latency, and approximately a 10-meter range, and a USB interface with approximately a 5 Gbps transfer rate, both secured by AES-128 encryption.

7. The system of claim 6, wherein said power supply comprises approximately a 3.7V 300 mAh lithium-ion battery providing up to approximately 15 hours of continuous operation, rechargeable via said USB interface.

8. The system of claim 1, wherein said tracer position sensor system is configured as a standalone module weighing approximately 15 grams, ergonomically contoured to rest over an ear of the user and secured with a flexible silicone clip.

9. The system of claim 1, wherein said tracer position sensor system is selected from the group consisting of ear piece, a virtual reality (VR) headset, and smart glasses.

10. The system of claim 9, wherein said tracer position sensor system is integrated into said VR headset, leveraging a headset's framework to align sensors with a facial plane of the user, minimizing additional hardware.

11. The system of claim 1, further comprising a configuration/calibration tool executable on a computing device, said tool having a graphical user interface (GUI), and configured to allow the user to map specific exterior body part movements to customizable HMI commands.

12. The system of claim 11, wherein said configuration/calibration tool employs a convolutional neural network trained on a dataset of body movement patterns to process sensor data, and achieving a detection accuracy within approximately a 0.2 mm tolerance.

13. The system of claim 11, wherein said configuration/calibration tool stores a configuration profile, to enable portability across multiple computing devices via a cloud-based synchronization with encryption.

14. A body-driven human-machine interface (HMI) controller system by a user movement of an exterior body part, such as a facial location comprising:
a tracer configured as a neodymium magnetic marker affixed to the facial location of the user;
a tracer position sensor system positioned proximate to the facial location and having a Hall Effect sensor configured to detect micro-movements of said tracer; and
a processor control unit having a processor, a battery, a memory, and a communications system with a Bluetooth Low Energy (BLE) and a USB interfaces, configured to convert detected micro-movements into HMI commands with a processing latency of less than 5 ms; and
a configuration/calibration tool executable on a computing device, configured to map said micro-movements to user-defined HMI commands via a graphical user interface.

15. The system of claim 14, wherein the facial location is selected from the group consisting of a cheek, jawline, upper lip, lower lip, eyelid, eyebrow, forehead, and nose.

16. The system of claim 14, wherein said tracer position sensor system is integrated into a lightweight module positioned proximate an ear of the user.

17. The system of claim 14, wherein said tracer position sensor system is embedded in a secondary device selected from the group consisting of a VR headset and smart glasses.

18. The system of claim 14, wherein said configuration/calibration tool provides real-time feedback through a dynamic visualization dashboard displaying movement vectors and command triggers, enabling user-defined sensitivity adjustments within a 0.1-1.0 mm range.

19. A method for hands-free control of a computing device using a body-driven human-machine interface (HMI) controller, comprising the steps of:
affixing a tracer to an exterior body part of a user;
positioning a tracer position sensor system proximate to said tracer;
detecting, by said tracer position sensor system, a position change of the tracer corresponding to a movement of said exterior body part with a resolution of at least 0.3 mm;
processing, by a processor control unit, said detected position change into an HMI command using a machine learning algorithm;
transmitting said HMI command to the computing device via a communications system; and
configuring, via a configuration/calibration tool, a mapping of specific exterior body part movements to user-defined HMI commands.

20. The method of claim 19, wherein detecting said position change further comprising the step of sampling data at 120 Hz using a Hall Effect sensor.

21. The method of claim 19, wherein processing the detected position change further comprising the step of executing a convolutional neural network trained on a dataset of over thousand movement patterns, achieving a 98% classification accuracy with a processing latency of less than 5 ms.

22. The method of claim 19, wherein configuring said mapping further comprising the step of launching said configuration/calibration tool on a computing device;
prompting said user to perform a sequence of body part movements;
validating said sequence of body part movements against a baseline profile with a detection tolerance of 0.2 mm; and
saving a configuration profile to a memory of said tracer position sensor system and optionally to a cloud-based server.

23. The method of claim 19, wherein said HMI command is selected from the group consisting of a right mouse click, a left mouse click, cursor navigation, a pinch, and a selection command.
